(19) United States
(12) Patent Application Publication
(10) Pub. No.: US 2007/0132393 A1
(43) Pub. Date: Jun. 14, 2007

(54) Method for forming a dielectric layer in a plasma display panel

(75) Inventors: Young Hoon Kim, Chungcheongbuk-do (KR); Eun Tae Lee, Chungcheongbuk-do (KR); Woong Choi, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/435,713

(22) Filed: May 18, 2006

(30) Foreign Application Priority Data
Dec. 14, 2005 (KR) 10-2005-0122907

(51) Int. Cl. H01J 17/49

(52) U.S. Cl. 313/586

(57) ABSTRACT

A method of forming a dielectric layer in PDP is provided. The method according to the present invention comprises, (a) forming a green sheet comprising a base film and a film-forming layer disposed on a surface of the base film, wherein the film-forming layer is formed on the surface of the base film by applying onto said surface of the base film a slurry containing a PbO-based glass powder, a binder, a dispersing agent, a plasticizer and a solvent; (b) transferring the film-forming layer of the green sheet onto a surface of a substrate, wherein electrodes are disposed on the surface of the substrate; and (c) sintering the film-forming layer.

### BACKGROUND OF THE INVENTION

1. Field of the Invention

The present invention relates to a method for forming a dielectric layer in plasma display panel, particularly to a manufacturing method that a dielectric layer with high transmittance may be produced through reduced steps.

2. Description of the Related Art

Plasma display panel (PDP) is a flat panel display device that can display images or information by using the light-emitting phenomenon of plasma discharge. PDP s generally are divided into DC-types and AC-types according to the panel structure and driving method.

PDPs generate visible ray obtained from the energy difference when ultraviolet ray, which is generated by the plasma discharge of a gas (such as He, Xe, etc.) provided in each cell, excites a phosphor lining in the cell, which emits a visible photon when returning to the ground state.

The above mentioned PDPs have advantages such as easy manufacturing, simple structure, high brightness, high luminous efficacy, memory capacity, and a wide viewing angle over 160°. PDPs also can be used for wide screens of 40 inches or more.

Hereinafter, the basic structure of a PDP will be described.

The structure of a PDP generally includes an upper substrate and an oppositely disposed lower substrate thereto, barrier ribs, and cells defined by the two substrates and barrier ribs. Transparent electrodes are disposed on the upper substrate, and bus electrodes are disposed on the transparent electrodes in order to reduce the resistance of the transparent electrodes. Address electrodes, also called data electrodes, are formed on the lower substrate.

The cells divided by the barrier ribs are lined with phosphors. An upper dielectric layer is disposed on the upper substrate to cover the transparent electrodes and the bus electrodes, and a lower dielectric layer is disposed on the lower substrate as to cover the address electrodes. A protection layer, generally consisting of magnesium oxide, is disposed on the upper dielectric layer.

Hereinafter, the method for forming the upper dielectric layer will be described below.

First, a slurry comprising a glass powder is prepared, and then a film-forming layer is formed on an upper substrate which has the transparent electrodes and the bus electrodes thereon, by applying the slurry onto a surface of the upper substrate.

Subsequently, the film-forming layer on the upper substrate is subject to a thermal treatment along a pre-designed schedule, thereby obtaining the dielectric layer.

FIG. 1 is a diagram showing a schedule of thermal treatment during the manufacturing process for forming a dielectric layer of PDP in the related art.

Referring to FIG. 1, the conventional thermal treatment comprises a first temperature zone A where organic components of the film-forming layer are eliminated from and a second temperature zone B where the glass powder undergoes a solid-phase reaction at a high temperature so that the film-forming layer may be sintered.

As described above, the conventional thermal treatment process for forming the upper dielectric layer requires the temperature zone A for removing organic components of the film-forming layer, and another temperature zone B for proceeding actual sintering.

Under the conventional slurry composition and process condition of forming the upper dielectric layer, the temperature zone for removing organic components in the film-forming layer must be secured before sintering of the film-forming layer is performed in order to obtain less porous dielectric layer which are structurally dense and have over a certain degree of transmittance.

Therefore, it renders the process complex and delayed, and thus the manufacturing cost is increased as well.

### SUMMARY OF THE INVENTION

An object of the present invention is to provide a method of forming a dielectric layer in PDP with which the dielectric layer may be obtained by directly sintering a film-forming layer without any separate temperature zone for eliminating organic components in the film-forming layer.

Another object of the present invention is to provide an optimal sintering condition to obtain the dielectric layer having reliable physical and optical properties in a reduced process time.

In one embodiment of the present invention, the method of forming a dielectric layer for use in PDP comprises, (a) forming a green sheet comprising a base film and a film-forming layer disposed on a surface of the base film, wherein the film-forming layer is formed on the surface of the base film by applying a slurry containing a PbO-based glass powder, a binder, a dispersing agent, a plasticizer and a solvent, onto said surface of the base film; (b) transferring the film-forming layer of the green sheet onto a surface of a substrate, wherein electrodes are disposed on the surface of the substrate; and (c) sintering the film-forming layer, wherein the film-forming layer is sintered at a sintering temperature of between 570° C. and 600° C., and wherein the film-forming layer is heated to the sintering temperature at a heating rate of from 4° C./min to 10° C./min.

In another embodiment of the present invention, the method for forming a dielectric layer for use in PDP, the method comprises, (a) forming a film-forming layer by applying a slurry containing a PbO-based glass powder, a binder, a dispersing agent, a plasticizer and a solvent, onto a surface of a substrate having electrodes disposed thereon; and (b) sintering the film-forming layer, wherein the film-forming layer is sintered at a sintering temperature of between 570° C. and 600° C., and wherein the film-forming layer is heated to the sintering temperature at a heating rate of from 4° C./min to 10° C./min.

In another embodiment of the present invention, the method for forming a dielectric layer for use in PDP comprises, (a) forming a film-forming layer on a surface of a substrate having electrodes disposed thereon by using a slurry, wherein the slurry contains about 50 wt % to 70 wt % of a PbO-based glass powder; about 15 wt % to 25 wt % of a binder; about 0.1 wt % to 2 wt % of a dispersing agent; about 0.1 wt % to 5 wt % of a plasticizer; and about 10 wt % to 30 wt % of a solvent; and (b) sintering the film-forming layer, wherein the film-forming layer is heard to a sintering temperature of between 570° C. and 600° C. at a heating rate of from 4° C./min to 10° C./min.

The methods of forming a dielectric layer in PDP according to the present invention have an advantage to proceed with the sintering process without setting a separate period for removing organic components, thereby simplifying the sintering process and further reducing the time required for the sintering process.

In addition, the method of forming a dielectric layer in PDP according to the present invention has another advantage to produce the dielectric layer having the properties needed in the dielectric layer for use in PDP in a reduced process time.

### BRIEF DESCRIPTION OF THE DRAWINGS

These and other features, aspects and advantages of the present invention will become better understood with regard to the following description, appended claims, and accompanying drawings where:

FIG. 1 is a diagram showing a schedule of thermal treatment during the manufacturing process for forming a dielectric layer of PDP in the related art.

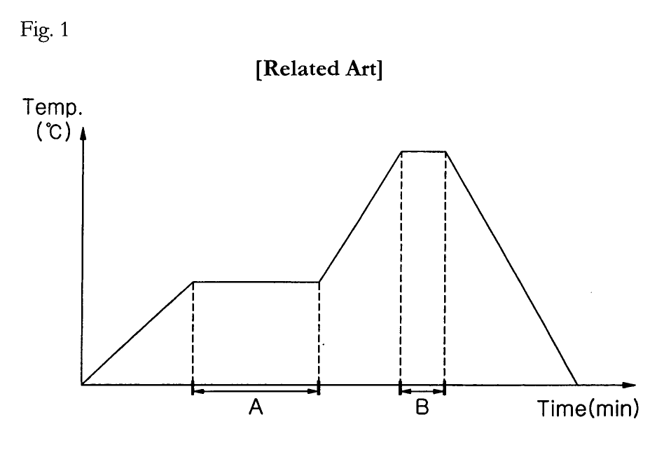

FIG. 2 is a cross-sectional view of PDP according to a preferred embodiment of the present invention.

FIG. 3 is a diagram showing a schedule of thermal treatment during the manufacturing process for forming the dielectric layer of FIG. 2 according to a preferred embodiment of the present invention.

### DETAILED DESCRIPTION OF THE INVENTION

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Hereinafter, a method of forming a dielectric layer in PDPs according to a preferred embodiment of the present invention now will be described in detail with reference to the accompanying drawings.

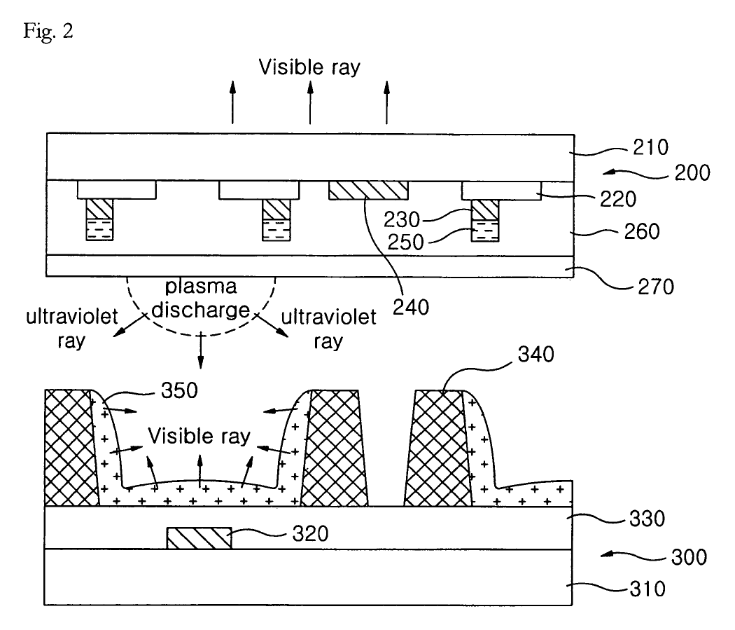

FIG. 2 is a cross-sectional view of a PDP according to a preferred embodiment of the present invention.

FIG. 2 shows that the structure of the PDP is divided into an upper plate 200 and a lower plate 300. In the upper plate 200, transparent electrodes 220, bus electrodes 250, a fist and second black matrix 240 and 240, an upper dielectric layer 260, and a protection layer 270 are formed on the lower side of a glass substrate 210 (hereinafter, referred to as “upper substrate”).

The transparent electrodes 220 are made of transparent conductive material such as indium tin oxide (ITO) or indium zinc oxide (IZO) to transmit the light generated from the discharge cells.

The bus electrodes 250 are present on the transparent electrodes 220 in order to reduce the line resistance of the transparent electrodes 220. The bus electrodes 250 may be made of silver (Ag) paste having a high conductivity. Since the bus electrodes 250 are generally made of a material with high electrical conductivity, they may reduce the driving voltage of the transparent electrodes 220 having a relatively low electrical conductivity.

The first black matrix 240 are present as a very thin layer between the transparent electrodes 220 and the bus electrodes 250, thereby to allow an electric current to pass through between the transparent electrodes 220 and the bus electrodes 250 and to enhance contrast on the PDP.

The second black matrix 240 is disposed between discharge cells to absorb outside light and inside transmitting light between adjacent discharge cells, thereby to enhance contrast. And the second black matrix 240 also serves to divide or compart the discharge cells.

The upper dielectric layer 260, which directly contacts the bus electrodes 250 made of a metallic material, may be made of PbO-based glass in order to avoid chemical reactions with the bus electrodes 250. The upper dielectric layer 260 restricts discharge current to maintain GLOW discharge, and the electric charges generated at the time of plasma discharge are deposited on the upper dielectric layer 260.

The protection layer 270 prevents damage of the upper dielectric layer sputtering at the time of plasma discharge, and increases the discharge efficiency of the secondary electrons. The protection layer 270 may be made of magnesium oxide (MgO).

In the lower plate 300 of the PDP, a glass substrate 310 (hereinafter, referred to as “lower substrate”), and address electrodes 320, a lower dielectric layer 330, barrier ribs 340, and a phosphor layer 350 are disposed on the upper surface of the lower substrate 310.

The address electrodes 320 are positioned at about the center of each discharge cell. The address electrodes 320 may have a line width of about 70 to 80 μm.

The lower dielectric layer 330 is disposed over the entire surface of the lower substrate 310 and the address electrodes 320, and the lower dielectric layer 330 protects the address electrodes 320.

The barrier ribs 340 are positioned on top of the lower dielectric layer 330 spaced at a predetermined distance from the address electrodes 320, and the barrier ribs 340 are formed to be longer in the perpendicular direction.

The barrier ribs 340 are present to maintain the discharge distance and prevent electrical and optical interference between adjacent discharge cells.

The phosphor layer 350 is formed on both sides of the barrier ribs 340 and the upper surface of the lower dielectric layer 330. The phosphor layer 350 is excited by the ultraviolet ray generated at the time of plasma discharge to generate red (R), green (G) or blue (B) visible ray.

Hereinafter, the light emitting mechanism of a PDP will be described in detail.

Under a predetermined voltage (within a voltage margin) between the transparent electrode 220 and the bus electrode 250, applying to the address electrodes 320 an additional voltage sufficient to create plasma, generate a plasma between the transparent electrode 220 and the bus electrode 250. A certain amount of free electrons exists in the gas, and a force (F=q·E) is exerted to the free electrons when an electrical field is applied to the gas.

If the force-exerted electrons obtain energy (first ionization energy) sufficient to remove electrons in the outermost orbit, they ionize the gas, and the ions and electrons created in the gas move to both electrodes by electromagnetic force. Particularly, secondary electrons are generated when the ions collide with the protection layer 250, and the secondary electrons help to create the plasma.

Thus, a high voltage creates an initial discharge, but once a discharge is initiated, a lower voltage is used as the electron density increases.

The gas provided in the cells of the PDP is generally an inert gas, such as Ne, Xe, He, etc. Particularly, when Xe is under a quasi stable state, an ultraviolet ray with a wavelength of between about 147 and 173 nm is generated and applied to the phosphor layer 350 to emit red, green or blue visible ray.

The color of visible ray emitted from each discharge cell is determined according to the kind of phosphor lining the discharge cell, and thus each discharge cell becomes a sub-pixel representing red, green or blue color.

The color of each discharge cell is controlled by combination of light emitted from the three sub-pixels. In case of this exemplary PDP, it is controlled at the time the plasma is generated.

The visible ray generated as described above is emitted to the outside of the cell through the upper substrate 210.

Hereinafter, the method of forming the dielectric layer in PDP will be described by an example of forming the upper dielectric layer 260.

A slurry to be applied onto the upper substrate 210 is prepared.

The slurry is produced by mixing and dispersing glass powder, binder, dispersing agent, plasticizer, and solvent.

Preferably, the slurry contains about 50 wt % to 70 wt % of a PbO-based glass powder; about 15 wt % to 25 wt % of a binder; about 0.1 wt % to 2 wt % of a dispersing agent; about 0.1 wt % to 5 wt % of a plasticizer; and about 10 wt % to 30 wt % of a solvent.

Also, the slurry may further contain an antifoaming agent and a leveling agent to improve property of the slurry. Preferably, the slurry contains about 1 wt % or less of an antifoaming agent and about 1 wt % or less of a leveling agent.

The glass powder may be PbO-based glass.

The binder may be preferably at least one selected from the group consisting of a methacrylic resin, an acrylic resin, and a mixture thereof. More preferably, the binder may be a methacrylic resin which has a low decomposition temperature.

The dispersing agent is a component for increasing the dispersion force of the glass powder, thereby preventing precipitation of the powder. The dispersing agent may be a polyamine armide based material

The plasticizer is a component for increasing the thermal plasticity, thereby facilitating a shaping at a high temperature. The plasticizer may be phthalate-based plasticizer, dioctyl adipate, dioctyl azolate, ester-based plasticizer, or a mixture thereof.

The solvent should have good affinity with inorganic particles and good ability to dissolve the binder to provide appropriate viscosity to the slurry. In addition, the solvent should be able to be easily vaporized when dried. The solvent may be at least one selected from the group consisting of toluene, propylene glycol mono methyl ether, butyl acetate, cyclo-hexanon and methyl ethyl ketone.

The antifoaming agent is an additive to eliminate bubbles in the mixture. The antifoaming agent may be hydrocarbon, ethyl-hexanol or a mixture thereof.

The leveling agent is an additive to apply the slurry uniformly. The leveling agent may be a polyhydroxycarboxylic acid amide-based leveling agent, an acrylate-containing leveling agent, or a mixture thereof.

After the slurry is prepared, a film-forming layer is formed on a surface of the upper substrate 210 where the transparent electrode and the bus electrodes 250 are disposed by using the slurry. The film-forming layer is a layer to become an upper dielectric layer 260 through sintering process.

There are several methods to form the film-forming layer by using the slurry.

In one embodiment, the film-forming layer may be produced by directly applying the slurry onto the upper substrate 210 by using a mesh, followed by drying it.

In another embodiment, the film-forming layer may be produced by forming a green sheet by using the slurry and transferring the green sheet onto the upper substrate 210. The green sheet may be formed by applying the slurry onto a supporting film and drying it.

Preferably, the film-forming layer is produced by the method in which the film-forming layer is formed by transferring the green sheet onto the upper substrate 210.

After the film-forming layer is formed on the upper substrate 210, the film-forming layer is subject to a thermal treatment for sintering the film-forming layer, thereby obtaining the upper dielectric layer 260.

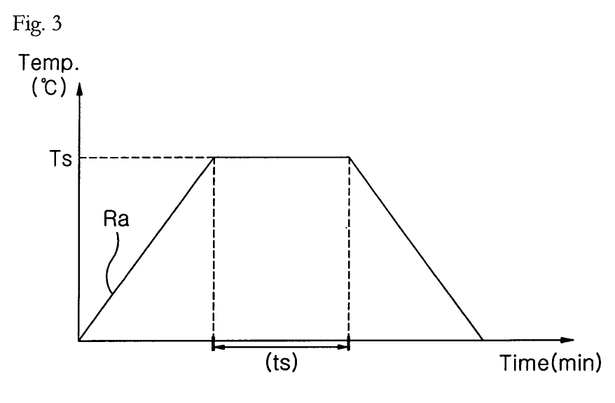

FIG. 3 is a diagram showing a schedule of thermal treatment during the manufacturing process for forming the dielectric layer of FIG. 2 according to a preferred embodiment of the present invention.

Referring to FIG. 3, the film-forming layer is heated to a sintering temperature Ts at a substantially same heating rate Ra. Preferably, the heating rate Ra is in between about 4° C./min and 10° C./min.

As the temperature of the film-forming layer is raised, the solvent contained in the film-forming layer evaporates at a temperature zone of between about 100° C. and 200° C., and organic components such as binder and plasticizer are decomposed and removed from the film-forming layer at a temperature zone of between about 250° C. and 450° C.

Subsequently, once the temperature of the film-forming layer reaches a sintering temperature Ts of between about 570° C. and 600° C., the temperature of the film-forming layer is maintained at the sintering temperature Ts for a certain period of time, i.e. a sintering time ts. Preferably, the sintering time ts is of between about 15 and 30 min.

When the temperature of the film-forming layer reaches the sintering temperature Ts, most organic components are decomposed and removed from the film-forming layer. And, inorganic particles such as glass powder of the film-forming layer are subject to a solid-phase reaction to be bonded at their grain boundary and solidified. Specifically, adhesion occurs between the inorganic particles, whereby the corresponding area is gradually increased. Then, channel shaped air gaps are contracted gradually, and the density and contraction increase, whereby the grain growth is conspicuously shown. As the density increases, the pores that the air passes through disappear, and bonding of the particles becomes denser.

Once the sintering time ts is over, the film-forming layer is cooled at a certain rate, whereby the upper dielectric layer 260 may be obtained.

As described above, in the present invention, there is no need to maintain the temperature of the film-forming layer at a temperature of below the sintering temperature Ts for a certain period of time to eliminate the organic components contained in the film-forming layer during the thermal treatment process.

Experimental results to the properties of the upper dielectric layer 260 are provided in the following table.

TABLE 1

| | Heating | Baking | Baking | Sintering | Sintering | | | |
|---|---|---|---|---|---|---|---|---|
| | Rate | Temp. | Time | Temp. | Time | Transmittance | Withstanding | |
| | (° C./min) | (° C.) | (min) | (° C.) | (min) | (%) | Voltage(kV) | Pores |
| Example 1 | 7 | | | 580 | 20 | 67-73 | ≧3.5 | good |
| Example 2 | 5 | | | 590 | 17 | 67-72 | ≧3.5 | good |
| Comparative | 5 | 400 | 10 | 590 | 17 | 67-72 | ≧3.5 | good |
| Example | | | | | | | | |

In Example 1, the heating rate is 7° C./min; the sintering temperature is 580° C.; and the sintering time is 20 minutes. In Example 2, the heating rate is 5° C./min; the sintering temperature is 590° C.; and the sintering time is 17 minutes.

In comparison, in the Comparative Example, the film-forming layer is heated at a heating rate of 5° C./min and baked at 400° C. for 10 minutes to eliminate the organic components contained in the film-forming layer, and then the film-forming layer is reheated to be sintered at 590° C. for 17 minutes.

In case pores are generated during the process of forming the upper dielectric layer 260, the transmittance of the layer is degraded due to light scattering around the pores. Table 1 shows that the transmittance of the dielectric layer of either Example 1 or 2 is over 67% , which confirms that the dielectric layer of either Example 1 or 2 has an optical property equivalent to the dielectric layer of the Comparative Example.

The withstanding voltage is to inspect the degree of pores occurrence; and is in inverse proportion to the amount of pores contained in the dielectric layer. Table 1 showed that the withstanding voltage of both Examples 1 and 2 is over 3.5 kV, which confirmed that the dielectric layer of either Example 1 or 2 has an equivalent withstanding voltage to the dielectric layer of the Comparative Example.

As described above, it is verified that the transmittance and withstanding voltage are sufficiently high, and the pore property of the upper dielectric layer 260 of Examples 1 and 2 is as good as that of the Comparative Example.

Without any separate temperature zone to eliminate the organic components that are needed in the art as described above, the present invention can obtain the upper dielectric layer 260 having good properties needed for use in PDP.

The preferred embodiments of the invention have been described for illustrative purposes, and those skilled in the art will appreciate that various modifications, additions, and substitutions are possible, without departing from the scope and spirit of the invention as disclosed in the accompanying claims.

What is claimed is:

1. A method for forming a dielectric layer for use in PDP comprising:
(a) forming a green sheet comprising:
a base film; and
a film-forming layer disposed on a surface of the base film, wherein the film-forming layer is formed on the surface of the base film by applying onto said surface of the base film a slurry containing a PbO-based glass powder, a binder, a dispersing agent, a plasticizer and a solvent;
(b) transferring the film-forming layer of the green sheet onto a surface of a substrate, wherein electrodes are disposed on the surface of the substrate; and
(c) sintering the film-forming layer, wherein the film-forming layer is sintered at a sintering temperature of between 570° C. and 600° C., and wherein the film-forming layer is heated to the sintering temperature at a heating rate of from 4° C./min to 10° C./min.

2. The method of claim 1, wherein the film-forming layer is sintered for about 15 minutes to 30 minutes.

3. The method of claim 1, wherein the slurry contains:
about 50 wt % to 70 wt % of a PbO-based glass powder;
about 15 wt % to 25 wt % of a binder;
about 0.1 wt % to 2 wt % of a dispersing agent;
about 0.1 wt % to 5 wt % of a plasticizer; and
about 10 wt % to 30 wt % of a solvent.

4. The method of claim 1, wherein the slurry further comprises:
about 1 wt % or less of an antifoaming agent; and
about 1 wt % or less of a leveling agent.

5. The method of claim 4, wherein the antifoaming agent is a hydrocarbon, ethyl-hexanol or a mixture thereof.

6. The method of claim 4, wherein the leveling agent is a polyhydroxycarboxylic acid amide-based leveling agent, an acrylate-containing leveling agent, or a mixture thereof.

7. The method of claim 1, wherein the binder is a methacrylic resin, an acrylic resin, or a mixture thereof.

8. The method of claim 1, wherein the dispersing agent is a polyamine amide based material.

9. The method of claim 1, the plasticizer is phthalate-based plasticizer, dioctyl adipate, dioctyl azolate, ester-based plasticizer, or mixture thereof.

10. The method of claim 1, wherein the solvent is at least one selected from the group consisting of toluene, propylene glycol mono methyl ether, butyl acetate, cyclo-hexanon, and methyl ethyl ketone.

11. A method for forming a dielectric layer for use in PDP comprising:
(a) forming a film-forming layer by applying onto a surface of a substrate having electrodes disposed thereon a slurry containing a PbO-based glass powder, a binder, a dispersing agent, a plasticizer and a solvent; and
(b) sintering the film-forming layer, wherein the film-forming layer is sintered at a sintering temperature of between 570° C. and 600° C., and wherein the film-forming layer is heated to the sintering temperature at a heating rate of from 4° C./min to 10° C./min.

12. The method of claim 11, wherein the film-forming layer is sintered for about 15 minutes to 30 minutes.

13. The method of claim 11, wherein the slurry contains:
about 50 wt % to 70 wt % of a PbO-based glass powder;
about 15 wt % to 25 wt % of a binder;
about 0.1 wt % to 2 wt % of a dispersing agent;
about 0.1 wt % to 5 wt % of a plasticizer; and
about 10 wt % to 30 wt % of a solvent.

14. The method of claim 1, wherein the slurry further comprises:
about 1 wt % or less of an antifoaming agent; and
about 1 wt % or less of a leveling agent.

15. The method of claim 14, wherein the antifoaming agent is a hydrocarbon, ethyl-hexanol or a mixture thereof, and wherein the leveling agent is a polyhydroxycarboxylic acid amide-based leveling agent, an acrylate-containing leveling agent or a mixture thereof.

16. The method of claim 11, wherein the binder is a methacrylic resin, an acrylic resin or a mixture thereof.

17. The method of claim 11, wherein the dispersing agent is a polyamine amide based material.

18. The method of claim 11, the plasticizer is phthalate-based plasticizer, dioctyl adipate, dioctyl azolate, ester-based plasticizer, or mixture thereof.

19. The method of claim 11, wherein the solvent is at least one selected from the group consisting of toluene, propylene glycol mono methyl ether, butyl acetate, cyclo-hexanon and methyl ethyl ketone.

20. A method for forming a dielectric layer for use in PDP comprising:
(a) forming a film-forming layer on a surface of a substrate having electrodes disposed thereon by using a slurry, wherein the slurry contains:
about 50 wt % to 70 wt % of a PbO-based glass powder;
about 15 wt % to 25 wt % of a binder;
about 0.1 wt % to 2 wt % of a dispersing agent;
about 0.1 wt % to 5 wt % of a plasticizer; and
about 10 wt % to 30 wt % of a solvent; and
(b) sintering the film-forming layer, wherein the film-forming layer is heated to a sintering temperature of between 570° C. and 600° C. at a heating rate of from 4° C./min to 10° C./min.
